(19) United States
(12) Patent Application Publication
(10) Pub. No.: US 2010/0245655 A1
(43) Pub. Date: Sep. 30, 2010

(54) IMAGE CAPTURING DEVICE AND AUTO-FOCUS METHOD FOR THE SAME

(75) Inventor: Jin-Chong Ou, Foshan (CN)

Correspondence Address: Altis Law Group, Inc.;ATTN: Steven Reiss, 288 SOUTH MAYO AVENUE, CITY OF INDUSTRY, CA, 91789, US

(73) Assignees: PREMIER IMAGE TECHNOLOGY(CHINA) LTD., Foshan City, Guangdong Province (CN); HON HAI PRECISION INDUSTRY CO., LTD., Tu-Cheng (TW)

(21) Appl. No.: 12/497,552

(22) Filed: Jul. 3, 2009

(30) Foreign Application Priority Data
Mar. 25, 2009 (CN) 200910301131.2

(51) Int. Cl. H04N 5/232; H04M 1/00; G06F 3/041

(52) U.S. Cl. 348/345; 455/556.1; 345/173; 348/E05.045

(57) ABSTRACT

An image capturing device includes a taking lens, an image sensor, a driving device, an input device, and an auto-focus system. The input device is used for selecting a number of focus areas in a photographing area. The auto-focus system includes an auto-focus module, a calculating module, and a driving module. The auto-focus module controls the image capturing device to focus on each focus area alone to obtain a number of in-focus positions of the taking lens corresponding to the number of focus areas. The calculating module calculates distances between a predetermined starting position of the taking lens and the in-focus positions of the taking lens, and averaging the distances to obtain an average distance. The driving module controls the driving device to move the taking lens the average distance to arrive at an in-focus position of the taking lens corresponding to the plurality of focus areas.

### BACKGROUND

1. Technical Field

The present disclosure relates to image capturing devices and, particularly, to an image capturing device using multi-area auto-focus method.

2. Description of Related Art

Cameras normally have an AF (auto-focus) function for automatically moving the taking lens therein to an in-focus position to capture clear images. A conventional camera having AF function uses focus frames on an electronic view finder thereof to inform the user that the camera is now focused on that part of objects whose images are surrounded by the focus frames. However, the position and the number of the focus frames on the electronic view finder of the conventional camera are usually predetermined. As a result, the object whose image is not surrounded by the focus frames cannot be focused on, and the image of that object in the photo captured later may not be clear.

What is needed, therefore, is an image capturing device and an auto-focus method thereof to overcome the above-described problem.

### BRIEF DESCRIPTION OF THE DRAWINGS

Many aspects of the present image capturing device and auto-focus method can be better understood with reference to the accompanying drawings. The components in the drawings are not necessarily drawn to scale, the emphasis instead being placed upon clearly illustrating the principles of the present image capturing device and auto-focus method. In the drawings, all the views are schematic.

FIG. 1 is a functional block diagram of an image capturing device according to an exemplary embodiment.

FIG. 2 is a functional block diagram of an auto-focus system of the image capturing device of FIG. 1.

FIG. 3 is a flowchart of an auto-focus method according to an exemplary embodiment.

### DETAILED DESCRIPTION

Embodiments of the present disclosure will now be described in detail below, with reference to the accompanying drawings.

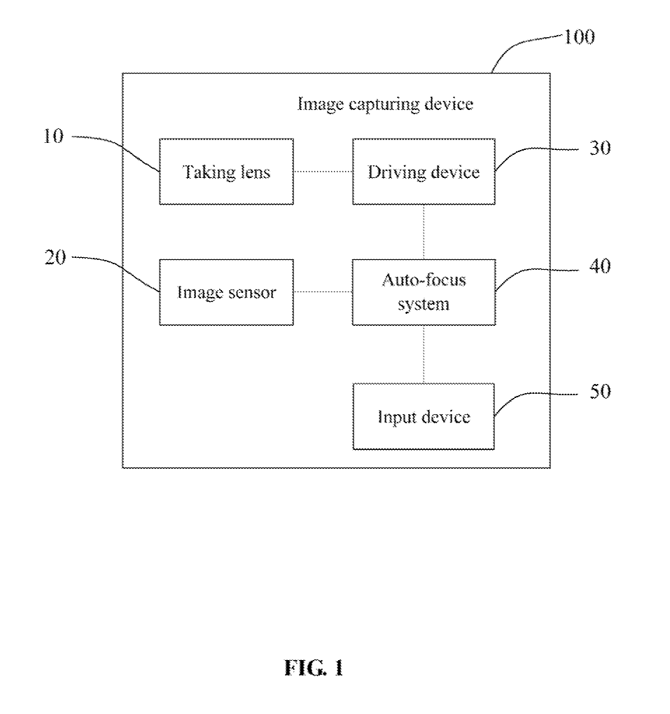

Referring to the FIG. 1, an image capturing device 100, according to an exemplary embodiment, is shown. The image capturing device 100 includes a taking lens 10, an image sensor 20, a driving device 30, an auto-focus system 40, and an input device 50. The image capturing device 100 can, for example, be a digital camera, a video camera, or a mobile phone with image capturing function.

The taking lens 10 can include many lenses capable of being divided into several lens groups. The taking lens 10 can be a zoom lens or a lens with a fixed focal length.

The image sensor 20 is configured for converting light transmitted through the taking lens 10 to electrical signals. The image sensor 20 is typically a charge-coupled device (CCD) or a complementary metal oxide semiconductor (CMOS) device. The image sensor 20 can further be selected from a group consisting of a ceramic leaded chip carrier (CLCC) package type image sensor, a plastic leaded chip carrier (PLCC) package type image sensor, and a chip scale package (CSP) type image sensor.

The input device 50 is used for selecting a number of focus areas in a photographing area formed by the taking lens 10 before capturing an image. The input device 50 can be a touch screen or a button. In the present embodiment, the input device 50 is a touch screen, which can also be used as a view finder of the image capturing device 100. Preferably, the touch screen is a liquid crystal monitor. Thus, users can select focus areas on the touch screen intuitively.

The driving device 30 is configured for moving the taking lens 10 back and forth under control of the auto-focus system 40. The driving device 30 moves the taking lens 10 during the process of detecting the in-focus position of the taking lens 10, and moves the taking lens 10 to the in-focus position once the in-focus position of the taking lens 10 is detected. In the present embodiment, the driving device 30 is a motor.

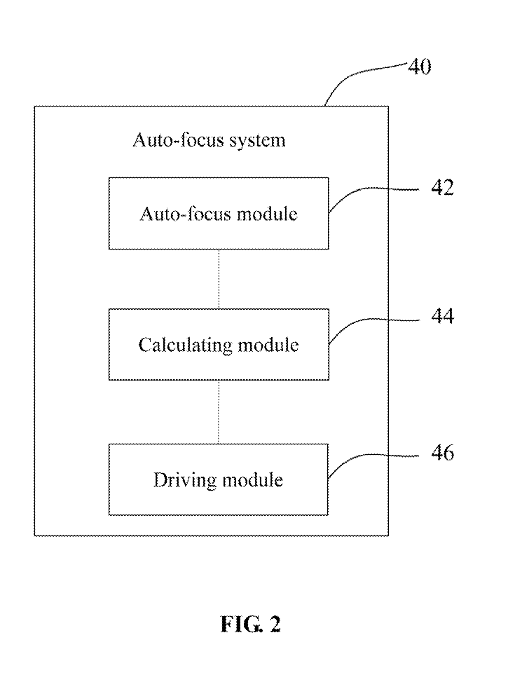

Referring to FIG. 2, the auto-focus system 40 includes an auto-focus module 42, a calculating module 44, and a driving module 46.

The auto-focus module 42 is configured for controlling the image capturing device 100 to focus on each focus area alone to obtain a number of in-focus positions of the taking lens 10 corresponding to the number of focus areas. For example, if the user selects a first focus area and a second focus area by using the input device 50, the auto-focus module 42 will control the image capturing device 100 to focus on the first focus area first, and obtain a first in-focus position of the taking lens 10 corresponding to the first focus area. Then, the auto-focus module 42 will control the image capturing device 100 to focus on the second focus area, and obtain a second in-focus position of the taking lens 10 corresponding to the second focus area.

The taking lens 10 has a starting position during the focus process of the image capturing device 100. The calculating module 44 calculates a number of distances between the starting position of the taking lens 10 and the number of in-focus positions of the taking lens 10, and then average the number of distances to obtain an average distance. The average distance will be considered as the distance between the starting position and an in-focus position of the taking lens 10 corresponding to the number of focus areas.

The driving module 46 is configured for controlling the driving device 30 to move the taking lens 10 the average distance to arrive at the in-focus position of the taking lens 10 corresponding to the number of focus areas.

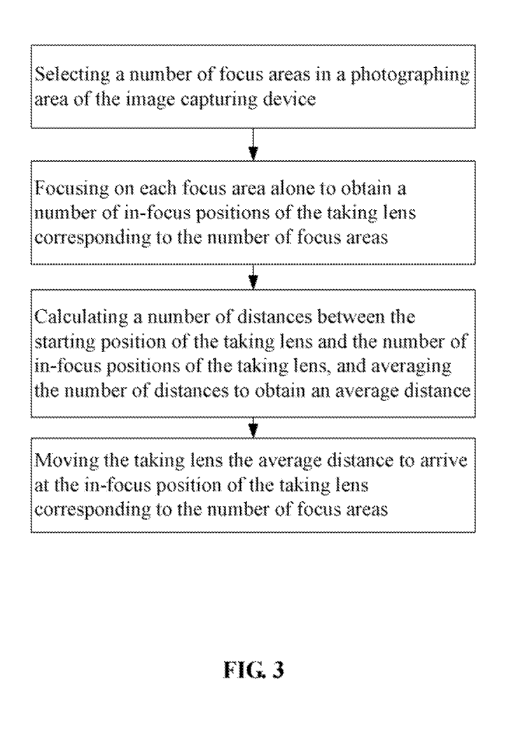

Referring to FIG. 3, a flowchart of an auto-focus method for the image capturing device 100 is shown. The method includes the steps of: selecting a number of focus areas in a photographing area of the image capturing device 100; focusing on each focus area alone to obtain a number of in-focus positions of the taking lens 10 corresponding to the number of focus areas; calculating a number of distances between the starting position of the taking lens 10 and the number of in-focus positions of the taking lens 10, and averaging the number of distances to obtain an average distance; and moving the taking lens 10 the average distance to arrive the in-focus position of the taking lens 10 corresponding to the number of focus areas.

While certain embodiments have been described and exemplified above, various other embodiments will be apparent to those skilled in the art from the foregoing disclosure. The invention is not limited to the particular embodiments described and exemplified, and the embodiments are capable of considerable variation and modification without departure from the scope and spirit of the appended claims.

What is claimed is:

1. An image capturing device comprising:
a taking lens;
an image sensor configured for converting light transmitted through the taking lens into electrical signals;
a driving device for moving the taking lens;
an input device used for selecting a plurality of focus areas in a photographing area formed by the taking lens before an image of the photographing area is captured; and
an auto-focus system comprising:
an auto-focus module capable of controlling the image capturing device to focus on each focus area alone to obtain a plurality of in-focus positions of the taking lens corresponding to the plurality of focus areas;
a calculating module for calculating a plurality of distances between a predetermined starting position of the taking lens and the plurality of in-focus positions of the taking lens, and averaging the plurality of distances to obtain an average distance;
a driving module for controlling the driving device to move the taking lens the average distance to arrive at an in-focus position of the taking lens corresponding to the plurality of focus areas.

2. The image capturing device of claim 1, wherein the image capturing device is selected from the group consisting of a digital camera, a video camera, and a mobile phone.

3. The image capturing device of claim 1, wherein the image sensor is one of a charge-coupled device or a complementary metal oxide semiconductor device.

4. The image capturing device of claim 1, wherein the image sensor is selected from the group consisting of a ceramic leaded chip carrier package type image sensor, a plastic leaded chip carrier package type image sensor, and a chip scale package type image sensor.

5. The image capturing device of claim 1, wherein the input device is a button.

6. The image capturing device of claim 1, wherein the input device comprises a touch screen which is used as a view finder of the image capturing device.

7. An auto-focus method for an image capturing device, the method comprising:
selecting a plurality of focus areas in a photographing area of the image capturing device;
focusing on each focus area alone to obtain a plurality of in-focus positions of the taking lens of the image capturing device corresponding to the plurality of focus areas;
calculating a plurality of distances between a predetermined starting position of the taking lens and the plurality of in-focus positions of the taking lens, and averaging the number of distances to obtain an average distance; and
moving the taking lens the average distance to arrive at the in-focus position of the taking lens corresponding to the plurality of focus areas.

8. The method as claimed in claim 7, wherein the image capturing device is selected from the group consisting of a digital camera, a video camera, and a mobile phone.
